(19) United States
(12) Patent Application Publication
(10) Pub. No.: US 2007/0135221 A1
(43) Pub. Date: Jun. 14, 2007

(54) Cross groove constant velocity universal joint

(76) Inventors: Naohiro Une, Iwata-shi (JP); Yoshihiko Hayama, Iwata-shi (JP); Tatsuro Sugiyama, Iwata-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/546,419

(22) Filed: Oct. 12, 2006

(30) Foreign Application Priority Data
Dec. 12, 2005 (JP) 2005-357821

(51) Int. Cl. F16D 3/00

(52) U.S. Cl. 464/144

(57) ABSTRACT

A cross groove constant velocity universal joint of which weight of the outer ring is reduced. The cross groove constant velocity universal joint includes a disc-shaped outer ring having ball tracks in the inner circumferential surface, an inner ring having ball tracks in the outer circumferential surface, balls set between the pairs of the outer ring ball tracks and the inner ring ball tracks, and a cage that retains all the balls within the same plane. Bolt holes are arranged between adjacent ball tracks of the outer ring, and recesses are formed such as to reduce the outside diameter of the outer ring except for both axial ends, at least between adjacent bolt holes.

### BACKGROUND OF THE INVENTION

1. Field of the Invention

The present invention relates to cross groove constant velocity universal joints for use in transmission devices of automobiles, railroad vehicles, and various industrial machines.

2. Description of the Related Art

Cross groove constant velocity universal joints have pairs of inner and outer ring ball tracks that are oppositely inclined with respect to the axis. Adjacent ball tracks are oppositely inclined and balls, which are torque transmitting elements, are set in the intersections of the ball tracks (see E. R. Wagner, “Universal Joint and Driveshaft Design Manual,” SAE, 1991, p. 163-166, hereinafter referred to as non-patent document). There is little rattling between the balls and the ball tracks in such structure and it is commonly used particularly for vehicle driveshafts or propeller shafts, of which one requirement is little rattling.

The non-patent document shows the most basic type of cross groove constant velocity universal joint. It is described as having four or more, usually six, balls, with the ball tracks being designed to intersect with the axis at an angle such that, when the joint takes its maximum operating angle, the opposing outer and inner ring ball tracks are not parallel with each other, which is usually 13 to 19°.

Among various cross groove constant velocity universal joints, disc type joints (see FIG. 4 and FIG. 5) designed to be attached to vehicles are well known. Disc type cross groove constant velocity universal joints are bolt-fastened and therefore the outer ring includes circumferentially equally spaced bolt holes. These bolt holes are arranged between adjacent ball tracks so that the outside diameter of the outer ring need not be increased and that they are well-balanced with respect to the ball track positions. Consequently, the radial thickness of the outer ring, from the ball tracks to the outer circumference, is large (see FIG. 9), resulting in an increase in weight.

### SUMMARY OF THE INVENTION

A primary object of the present invention is to reduce the weight of the outer ring of cross groove constant velocity universal joint.

In this invention, the outside diameter of the outer ring is reduced by radially cutting part of the axially extending outer surface, to solve the problem. That is, the cross groove constant velocity universal joint of this invention includes an inner ring having ball tracks in an outer circumferential surface thereof, a disc-shaped outer ring having ball tracks in an inner circumferential surface, balls set between the pairs of the inner ring ball tracks and the outer ring ball tracks, and a cage that retains all the balls within the same plane, and is characterized in that bolt holes are arranged between adjacent ball tracks of the outer ring, and recesses are formed such as to reduce the outside diameter of the outer ring except for both axial ends, at least between adjacent bolt holes.

The outer ring ball tracks and the inner ring ball tracks that are oppositely inclined may intersect with an axis at an angle of 4.5° or more and less than 8.5°, the number of balls being eight. By setting the intersecting angle of the ball tracks of the cross groove constant velocity universal joint relative to the axis in the range of 4.5° or more and less than 8.5°, and with eight balls, the joint can have a reasonable maximum operating angle and a large sliding stroke. As mentioned before, in the cross groove constant velocity universal joint, when the balls are in a certain phase and the operating angle is too large, wedges are inverted and the balance of forces between the balls and the cage is lost, making the cage motion unstable. This phenomenon is evident when the angle made by the inner ring ball tracks and the outer ring ball tracks is small and the number of balls is six or less. However, by using eight or more balls, the cage motion can be made stable to a certain extent even when the angle made by the inner ring ball tracks and the outer ring ball tracks is made smaller. This is because, even when some balls have lost their drive force due to inverted wedges, this is made up for by other balls, making the cage motion stable.

The outer ring ball tracks and the inner ring ball tracks that are oppositely inclined may intersect with the axis at an angle of 10° or more and not more than 15°, the number of balls being ten, where the joint is for use in vehicle driveshafts.

In the case with cross groove constant velocity universal joints for driveshafts, by setting the intersecting angle of the ball tracks relative to the axis in the range of 10° or more and not more than 15°, and with ten balls, the joint can have a reasonable maximum operating angle and a large sliding stroke. As mentioned before, in the cross groove constant velocity universal joint, when the torque transmitting balls are in a certain phase and the operating angle is too large, the wedges are inverted and the balance of forces between the balls and the cage is lost, making the cage motion unstable. This phenomenon is evident when the angle made by the inner ring ball tracks and the outer ring ball tracks is small and the number of balls is six or less. However, by using ten balls, the cage motion can be made stable to a certain extent even when the angle made by the inner ring ball tracks and the outer ring ball tracks is made smaller. This is because, even when some balls have lost their drive force due to inverted wedges, this is made up for by other balls, making the cage motion stable.

Cross groove constant velocity universal joints for driveshafts are required to have an operating angle of about 20°; through the analysis with various operating angles up to 25°, it has been ascertained that the joint can have better bending characteristics than the conventional six-ball type if the intersecting angle of the ball tracks relative to the axis is 10° or more.

Thus, the intersecting angle of the ball tracks relative to the axis is made smaller to increase the sliding stroke without reducing the maximum operating angle, and the joint can have excellent bending characteristics with little possibility of jamming when bent. This improves the work efficiency in the vehicle assembly process. When the inner and outer rings have the same intersecting angle relative to the axis, the joint is excellent both in constant velocity performance and bending characteristics.

Cross groove constant velocity universal joints with eight balls have better bending torque characteristics than the conventional six-ball joints. On the other hand, if the number of balls is eight, the pairs of radially opposite ball tracks in the inner or outer ring are inclined oppositely relative to the axis, and these pairs of ball tracks cannot be machined at the same time, which leads to poor machining efficiency, low productivity, and high costs. In contrast, with ten balls, the pairs of radially opposite ball tracks in the inner or outer ring are inclined in the same direction relative to the axis. Therefore, these pairs of ball tracks can be machined at the same time, and thus ball tracks are machined with good efficiency, leading to good productivity and lower costs.

The outer ring ball tracks and the inner ring ball tracks that are oppositely inclined may intersect with the axis at an angle of 5° or more and not more than 9°, the number of balls being ten, where the joint is for use in vehicle propeller shafts.

In the case with cross groove constant velocity universal joints for propeller shafts, by setting the intersecting angle of the ball tracks relative to the axis in the range of 5° or more and not more than 9°, and with ten balls, the joint can have a reasonable maximum operating angle and a large sliding stroke. As mentioned before, in the cross groove constant velocity universal joint, when the torque transmitting balls are in a certain phase and the operating angle is too large, the wedges are inverted and the balance of forces between the balls and the cage is lost, making the cage motion unstable. This phenomenon is evident when the angle made by the inner ring ball tracks and the outer ring ball tracks is small and the number of balls is six or less. However, by using ten balls, the cage motion can be made stable to a certain extent even when the angle made by the inner ring ball tracks and the outer ring ball tracks is made smaller. This is because, even when some balls have lost their drive force due to inverted wedges, this is made up for by other balls, making the cage motion stable.

Cross groove constant velocity universal joints for propeller shafts are required to have an operating angle of about 10°; through the analysis with various operating angles up to 15°, it has been ascertained that the joint can have better bending characteristics than the conventional six-ball type if the intersecting angle of the ball tracks relative to the axis is 5° or more.

Thus, the intersecting angle of the ball tracks relative to the axis is made smaller to increase the sliding stroke without reducing the maximum operating angle, and the joint can have excellent bending characteristics with little possibility of jamming when bent. This improves the work efficiency in the vehicle assembly process. When the inner and outer rings have the same intersecting angle relative to the axis, the joint is excellent both in constant velocity performance and bending characteristics.

Cross groove constant velocity universal joints with eight balls have better bending torque characteristics than the conventional six-ball joints. On the other hand, if the number of balls is eight, the pairs of radially opposite ball tracks in the inner or outer ring are inclined oppositely relative to the axis, and these pairs of ball tracks cannot be machined at the same time, which leads to poor machining efficiency, low productivity, and high costs. In contrast, with ten balls, the pairs of radially opposite ball tracks in the inner or outer ring are inclined in the same direction relative to the axis. Therefore, these pairs of ball tracks can be machined at the same time, and thus ball tracks are machined with good efficiency, leading to good productivity and lower costs.

According to the invention, the weight of the outer ring is reduced, as it is reduced in radial dimension or thickness from the ball tracks to the outer circumference except for both axial ends, at least between adjacent bolt holes. Therefore, according to the invention, a weight reduction of the outer ring, and consequently of the entire cross groove constant velocity universal joint, is achieved. Since the recesses are formed in the part except for both axial ends, there is no need to change the shape of attachment parts for an end cap for sealing in grease and for a boot. The currently used end cap and boot can therefore be used as they are. Further, this invention is applicable irrespective of the number of balls and it can be applied, for example, to commonly known joints that use six balls, as well as other cross groove constant velocity universal joints that use more number of balls.

Even though the intersecting angle of the ball tracks relative to the axis is made smaller in order to increase the sliding stroke of the cross groove constant velocity universal joint, there is little possibility of jamming when the joint is bent, and therefore the maximum operating angle is not reduced. Accordingly, the sliding stroke is increased without reducing the maximum operating angle of the cross groove constant velocity universal joint.

If the intersecting angle of the ball tracks relative to the axis is 10° or more and not more than 15°, and the number of balls is ten, the intersecting angle of the ball tracks relative to the axis can be made smaller to increase the sliding stroke without reducing the maximum operating angle. Thus, the joint can have excellent bending characteristics with little possibility of jamming when bent, which improves the work efficiency in the vehicle assembly process. When the inner and outer rings have the same intersecting angle relative to the axis, the joint is excellent both in constant velocity performance and bending characteristics.

If the intersecting angle of the ball tracks relative to the axis is 5° or more and not more than 9°, and the number of balls is ten, the intersecting angle of the ball tracks relative to the axis can be made smaller to increase the sliding stroke without reducing the maximum operating angle. Thus, the joint can have excellent bending characteristics with little possibility of jamming when bent, which improves the work efficiency in the vehicle assembly process. When the inner and outer rings have the same intersecting angle relative to the axis, the joint is excellent both in constant velocity performance and bending characteristics.

### BRIEF DESCRIPTION OF THE DRAWINGS

FIG. 1A is an end view of the outer ring of one embodiment of the cross groove constant velocity universal joint of the invention;

FIG. 1B is a cross section taken along the line A-O-B of FIG. 1A;

FIG. 2A is an end view of the outer ring of a variation of the joint of FIG. 1;

FIG. 2B is a cross section taken along the line A-O-B of FIG. 2A;

FIG. 3A is an end view of the outer ring of another embodiment of the cross groove constant velocity universal joint;

FIG. 3B is a cross section taken along the line A-O-B of FIG. 3A;

FIG. 4 is a longitudinal cross-sectional view of a conventional cross groove constant velocity universal joint;

FIG. 5 is an end view of the joint of FIG. 4 from which the grease cap has been removed;

FIG. 6 is a developed view of the outer ring inner circumferential surface and the inner ring outer circumferential surface of the joint of FIG. 4;

FIG. 7 is a schematic cross-sectional view of the ball tracks of the joint of FIG. 4;

FIG. 8 is a schematic diagram showing the relationship between the balls and the ball tracks of the joint of FIG. 4;

FIG. 9 is an end view of the outer ring of the joint of FIG. 4;

FIG. 10 is a graph showing the relationship between the bending angle and bending torque;

FIG. 11 is a graph showing the relationship between the operating angle and bending torque in one embodiment of the invention;

FIG. 12 is a graph showing the relationship between the operating angle and bending torque of various models with different intersecting angles for use in driveshafts;

FIG. 13 is a graph showing the relationship between the operating angle and bending torque of various models with different intersecting angles for use in propeller shafts;

FIG. 14 is a graph showing the relationship between the contact ratio of balls and bending torque of various models with different numbers and contact ratios of balls; and

FIG. 15 is a graph showing the relationship between the intersecting angle and constant velocity performance of various models with different operating angles.

### DETAILED DESCRIPTION OF THE PREFERRED EMBODIMENTS

Preferred embodiments of the present invention will be hereinafter described with reference to the drawings.

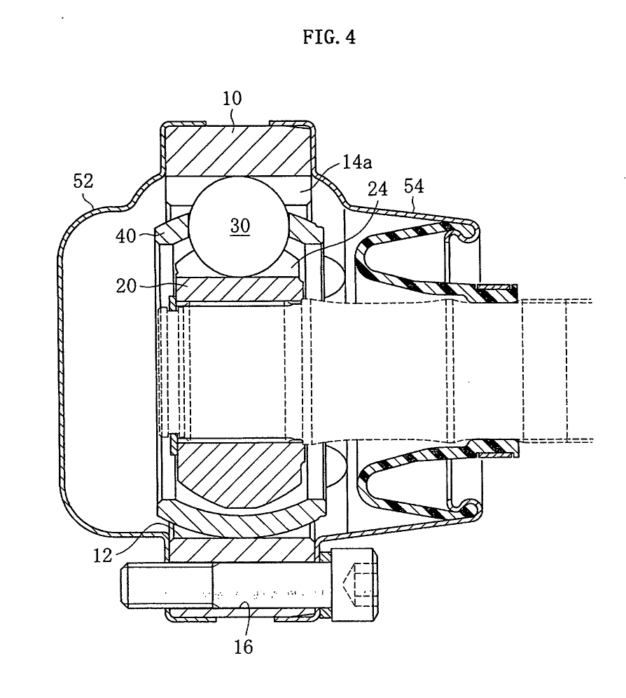

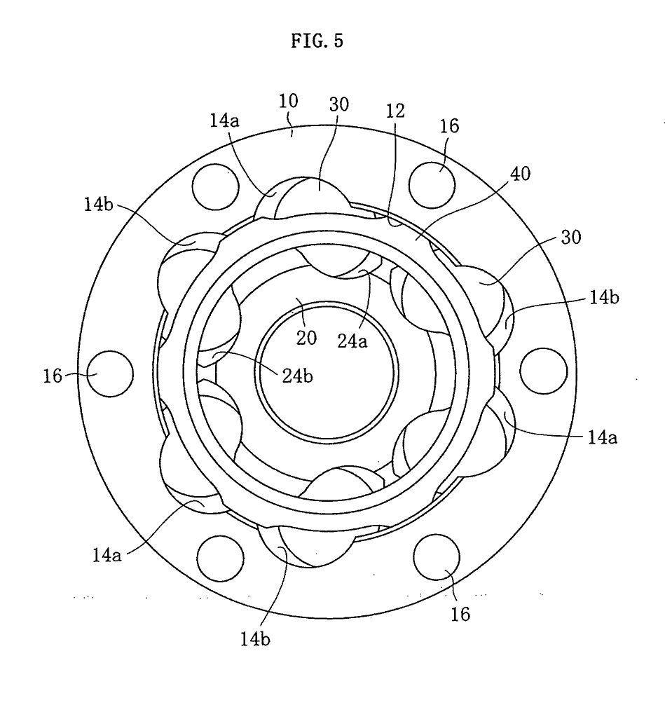

The basic structure of a conventional cross groove constant velocity universal joint is first described with reference to FIG. 4 to FIG. 7, which illustrate one such joint. As shown in FIG. 4 and FIG. 5, the cross groove constant velocity universal joint is mainly composed of an outer ring 10, an inner ring 20, balls 30, and a cage 40. The outer ring 10, which is an outer joint member, is disc-shaped and formed with ball tracks 14a and 14b in the inner circumferential surface 12. Similarly, the inner ring 20, which is an inner joint member, is formed with ball tracks 24a and 24b in the outer circumferential surface 22.

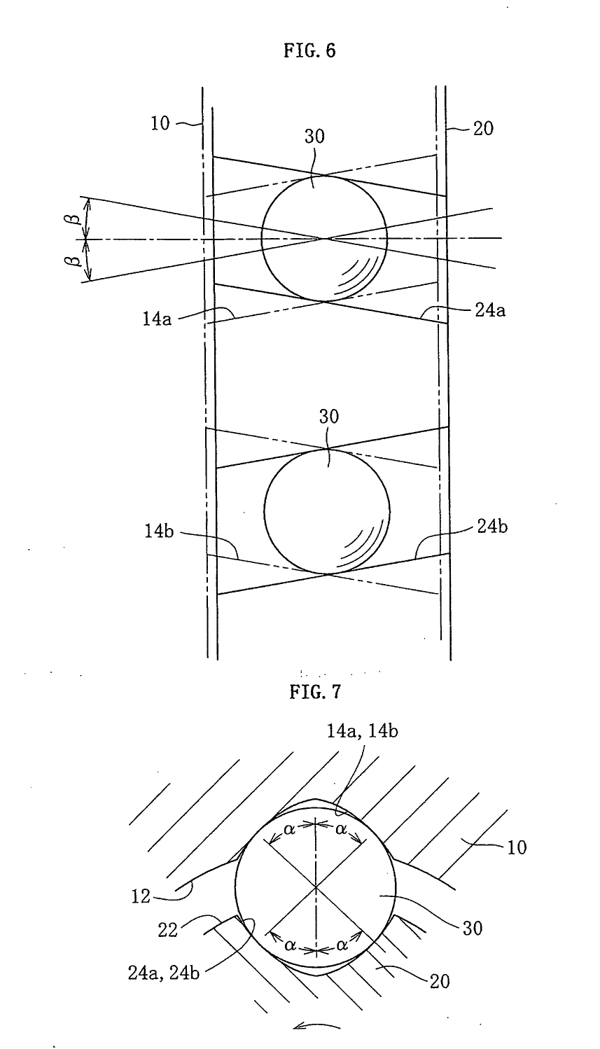

As shown in FIG. 6, the ball tracks 14a that are inclined to the axis of the outer ring 10 and the ball tracks 14b that are inclined to the outer ring axis oppositely from the ball tracks 14a alternate circumferentially. Similarly, the ball tracks 24a that are inclined to the axis of the inner ring 20 and the ball tracks 24b that are inclined to the inner ring axis oppositely from the ball tracks 24a alternate circumferentially.

The intersecting angle of each ball track 14a, 14b, 24a, and 24b with respect to the axis is denoted at β. The ball track 14a of the outer ring 10 is oppositely inclined from and paired with the ball track 24a of the inner ring 20; the angle they make is represented by 2β. Similarly, the ball track 14b of the outer ring 10 is oppositely inclined from and paired with the ball track 24b of the inner ring 20; the angle they make is represented by 2β.

Balls 30, which are torque transmitting elements, are set in intersections between the pairs of outer ring ball tracks 14a and the inner ring ball tracks 24a and between the pairs of outer ring ball tracks 14b and the inner ring ball tracks 24b.

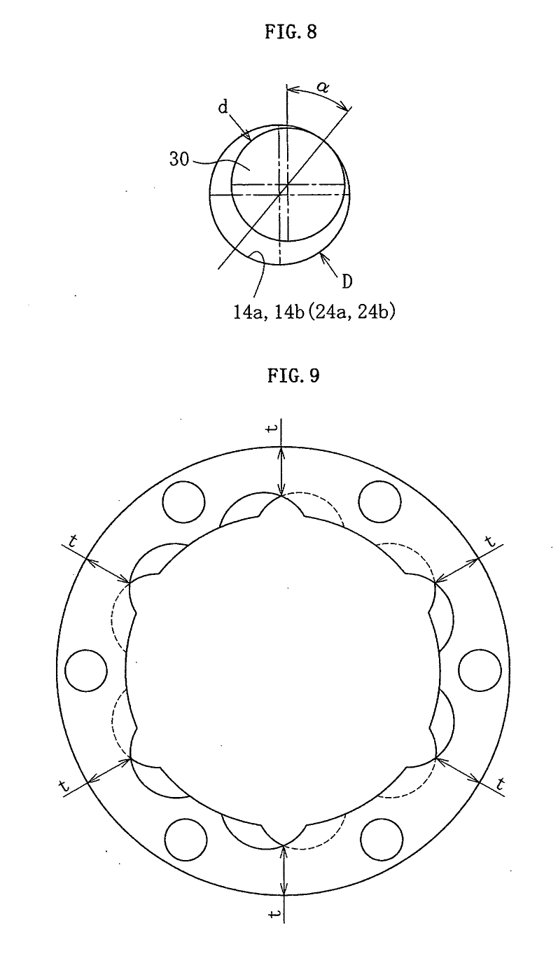

As shown in FIG. 7, the ball tracks 14a, 14b, 24a, and 24b of the outer ring 10 and inner ring 20 generally have a Gothic-arch shaped or elliptic cross section, and the balls 30 make angular contact with the ball tracks 14a, 14b, 24a, and 24b. The contact angle α of this angular contact is, for example, in the range of from 30 to 50°. FIG. 8 is a schematic representation of the relationship between the balls 30 and the ball tracks 14a, 14b, 24a, and 24b; the ratio of the ball diameter d to the groove diameter D (D/d) is referred to as “contact ratio”.

As shown in FIG. 9, the outer ring 10 of the conventional cross groove constant velocity universal joint has a circular outer shape. Also, as can be seen from FIG. 4, the outer ring 10 has a cylindrical outer circumferential surface, with an end cap 52 fitted to one end to seal the grease and with a boot adaptor 54 fitted to the other end to form part of the boot. Therefore, as indicated by t in FIG. 9, the radial thickness from the ball tracks to the outer circumference is large, which was causing an increase in weight.

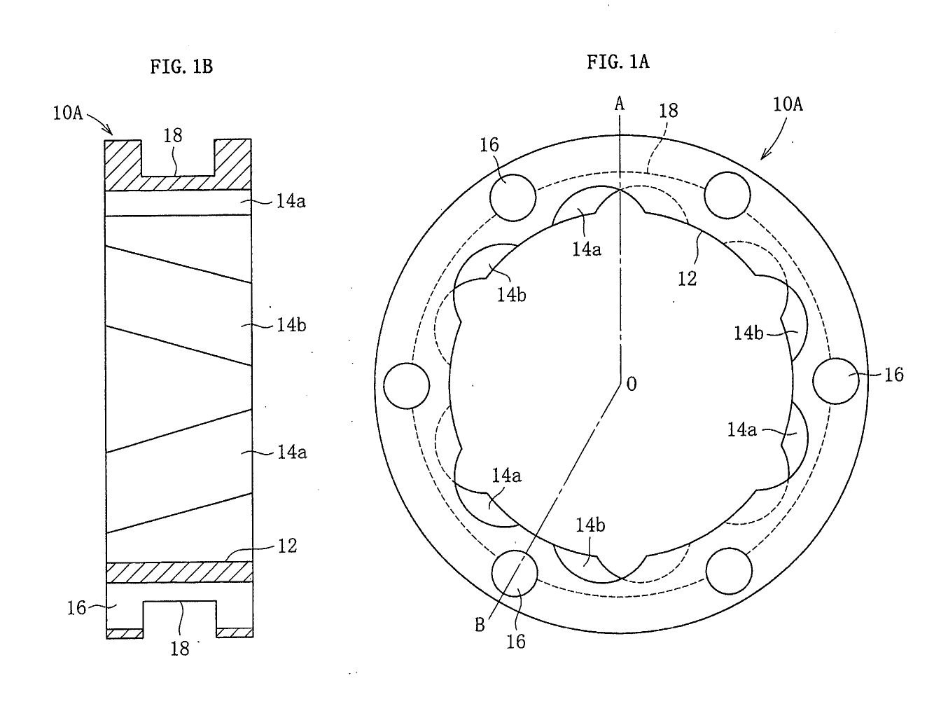

Next, preferred embodiments of the present invention will be described. FIG. 1 shows one end of the outer ring of one embodiment, which is a cross groove constant velocity universal joint using six balls. In this case, the outer ring 10A includes a total of six ball tracks 14a and 14b. Bolt holes 16 are circumferentially equally spaced in between the adjacent ball tracks 14a and 14b. Further, the outer ring 10A includes recesses 18 that are formed in parts except for the axial ends such as to reduce the outside diameter (FIG. 1B). As can be seen from FIG. 1A, the recesses 18 extend over the entire circumference of the outer ring 10A. Such recesses 18 can be formed easily, for example, using a turning machine.

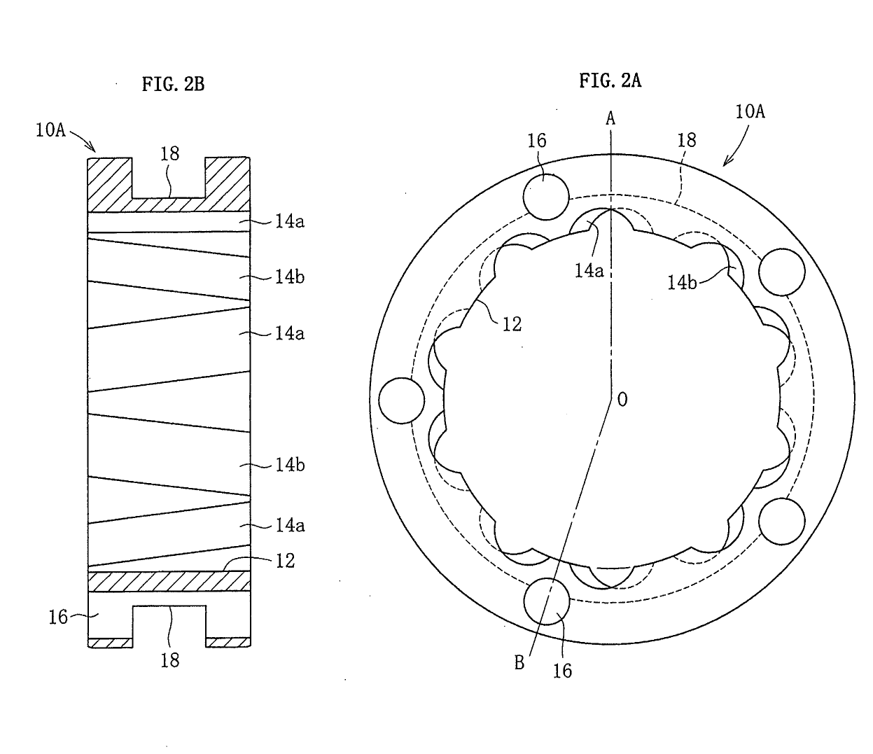

While the embodiment shown in FIG. 1 uses six balls 30 and therefore the outer ring 10A has six ball tracks 14a and 14b, FIG. 2 shows an end face of the outer ring 10A in another embodiment in which the number of the balls is ten.

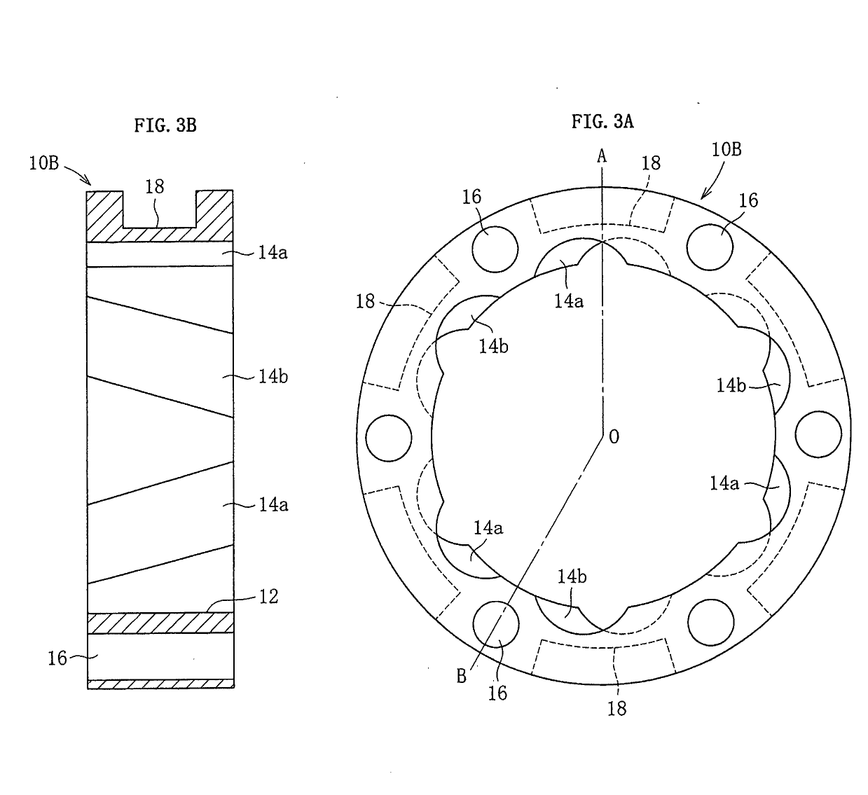

In yet another embodiment shown in FIG. 3, the recesses 18 are provided only in between the adjacent bolt holes 16 of the outer ring 10B. The recess 18 need not extend continuously over the entire circumference and may be provided intermittently as in this example. Such recesses 18 can be formed during a forging process, or by milling after forging.

As is clear from FIG. 1 to FIG. 3, in these embodiments, the outer ring 10A or 10B is reduced in weight as compared to conventional outer rings with cylindrical outer circumferential surfaces by the amount of the recesses 18 provided in the outer surface of the outer ring. From the viewpoint of the weight reduction, the recess 18 can take any shape. For example, other than the one with a rectangular cross section as shown in the drawing, it may have semicircular or other cross-sectional shapes.

It is generally understood that, basically, cross groove constant velocity universal joints cannot take a large operating angle. This is because of the limit of the operating angle (angle limit) of the joint at which the wedge formed by the inner and outer ring ball tracks is inverted. It is assumed that, if the operating angle of the joint exceeds this angle limit, the cage loses balance of forces and stability, whereby the joint loses its function as a constant velocity universal joint. This phenomenon has been ascertained with respect to common joints with six balls, and it is also known that the angle limit is determined by the contact angle and the intersecting angle of the ball tracks. Japanese unexamined Patent Publication No. H05-231435 shows a formulation of the possibility of making the angle limit larger by inclining the ball tracks also within the plane that contains the axis. However, this ball track shape is very hard to achieve in terms of production and quality control.

In cross groove constant velocity universal joints, the pairs of inner and outer ring ball tracks make wedges at their intersections, and the balls are pushed toward the pocket surfaces of the cage by the act of the wedge corners. Thus the balls are always kept at the intersections of the ball tracks, and even when there is an angle change between the inner and outer rings, they are maintained within the bisecting plane of the operating angle. The cross groove constant velocity universal joints are thus excellent in that they have good constant velocity performance with little rattling.

On the other hand, the operating angle of cross groove constant velocity universal joints is not as wide as that of other type of constant velocity universal joint that controls balls by offsetting the centers of circular arc ball tracks formed in the axial direction of the inner and outer rings. This is because the above-mentioned wedge is inverted when the operating angle becomes too large, whereupon the balance of forces between the balls and the cage is lost. As a result, the cage loses balance of forces and becomes unstable.

A possible solution would be to prevent the inversion of the wedge by making the intersecting angle of the inner and outer ring ball tracks larger. However, since the ball tracks of the inner and outer rings are inclined oppositely with respect to the axis and circumferentially alternated, and since adjacent ball tracks cannot interfere with each other, the intersecting angle can only be increased to a limited extent.

The angle 2β made by the inner and outer ring ball tracks of cross groove constant velocity universal joints also correlates with the sliding stroke of the joint; reducing the angle 2β made by the ball tracks is effective in increasing the stroke.

However, if the angle made by the inner and outer ring ball tracks is made small in order to increase the sliding stroke of the joint, the maximum operating angle of the joint is reduced. The maximum operating angle is the angle at which, in a non-rotating state, stretching back the joint that is once bent requires a large torque. In the worst case, the bent joint cannot be stretched back, that is, the joint is jammed. It would be a problem during assembly to an automobile if the joint jams when bent.

The joint needs to be bent once and stretched back when assembled to an automobile. Therefore, if the joint has a small-range operating angle and easily jams when bent, the work efficiency of assembling the joint to the automobile is poor.

It can therefore be seen that cross groove constant velocity universal joints have limited freedom of maximum operating angle and sliding stroke. It is desirable that the sliding stroke be large, without reducing the maximum operating angle of the cross groove constant velocity universal joint. In other words, it is desirable to provide a cross groove constant velocity universal joint, which has a reasonable maximum operating angle even though the intersecting angle of the ball tracks relative to the axis is made small in order to increase the sliding stroke and has excellent bending characteristics with less possibility of jamming when bent, whereby work efficiency in the vehicle assembly process is improved, and which is excellent in both constant velocity performance and bending characteristics if the inner ring and the outer ring have the same intersecting angle relative to the axis.

In order to find the maximum operating angle in the case with eight balls similarly to the case with six balls, the resistance torque when the joint is bent and stretched back at ±10° was determined through analysis, which revealed that, as the intersecting angle β of the ball tracks 14a, 14b, 24a, and 24b was made smaller, the joint did not jam until the intersecting angle β was 4.5°.

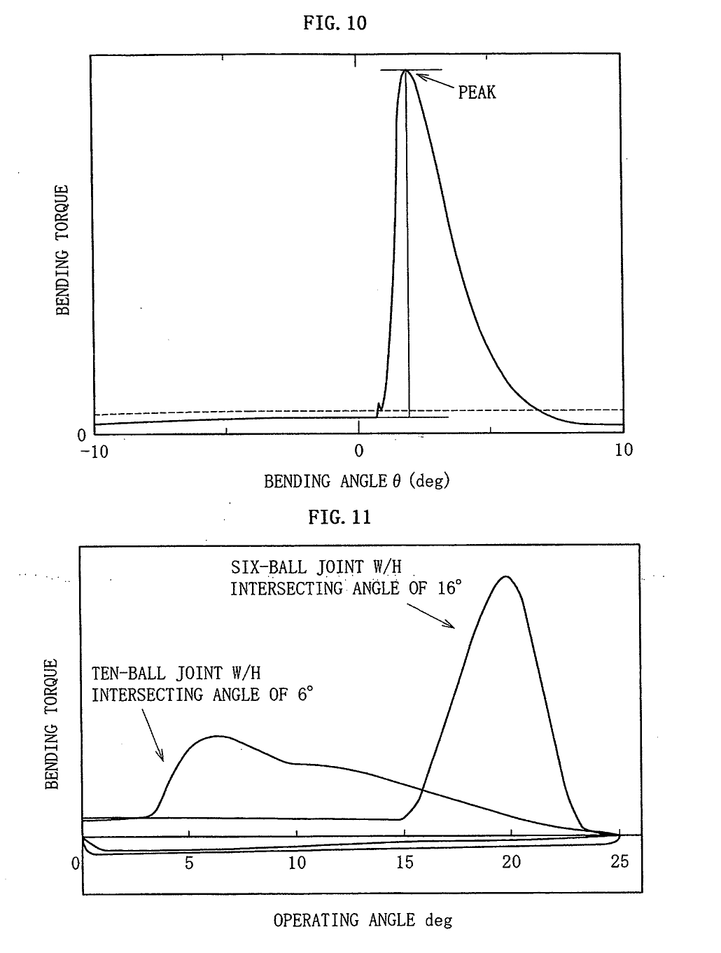

FIG. 10 shows the torque necessary for the bending in both conditions where the jamming occurs and where the jamming does not occur, the horizontal axis representing the bending angle θ, and the vertical axis representing the bending torque. As the solid-line torque curve indicates, in the condition where the jamming occurs, the torque has a large peak at a certain bending angle, as compared to the bending toque indicated by the broken line under the condition where the jamming does not occur. Whether the joint jams or not is determined by the presence of this peak.

Table 1 shows the results of the test in which, with respect to both cross groove constant velocity universal joints with six balls and with eight balls, it was determined with which angle the joint jams when bent and stretched back as the intersecting angle β of the ball tracks was made smaller. The bending angle θ was ±10°. The eligibility of the cross groove constant velocity universal joints is determined by whether the jamming occurred or not, circles indicating those eligible and crosses indicating those not eligible. Table 1 ascertains that, with eight balls, the cross groove constant velocity universal joint can function with the intersecting angle β being as small as 4.5°. With six balls, the jamming occurred when the intersecting angle β was 8°.

TABLE 1

Intersecting angle β (°)

| Number of balls | 4.0 | 4.5 | | 8.0 | 8.5 | 10.0 |
|---|---|---|---|---|---|---|
| 6 | X | X | [symbol] | X | ◯ | ◯ |
| 8 | X | ◯ | [symbol] | ◯ | ◯ | ◯ |

The angle limit was formerly formulated using the intersecting angle of ball tracks relative to the axis. This formula is effective irrespective of the number of balls. That is, the jamming must occur even if the number of balls is increased. However, as shown in Table 1, it was ascertained that, the jamming, which is caused by the wedges formed by the pairs of inner and outer ring ball tracks, did not occur, with eight or more balls. It is assumed that, as the number of balls is increased, even when the force applied to the cage from some balls in a certain phase is lost because of the wedge angle becoming zero, this is made up for by other balls, whereby the constant velocity universal joint is prevented from losing its stability.

Next, the jamming that occurs when the cross groove constant velocity universal joint is bent is described based on the analysis results. The jamming is a phenomenon where a large torque is required when the joint is stretched back from an operating angle. FIG. 10 shows the relationship between the bending angle and bending torque when the number of balls is six. The solid-line and broken-line torque curves represent the bending torques at different phases. As is seen from the solid-line torque curve in this graph, the torque has a peak at a certain bending angle when the jamming occurs.

The dimensions of the six-ball models used in the analysis were as follows: Ball diameter: ⅞ (22.225 mm); PCD: 58.0 mm; intersecting angle: 10°; and T100 torque: 748.5 Nm. The dimensions of the ten-ball models were as follows: Ball diameter: 19/32 (15.081 mm); PCD: 74.0 mm; intersecting angle: 5°; and T100 torque: 741.3 Nm.

FIG. 11 shows the relationship between the operating angle and bending torque with respect to the cross groove constant velocity universal joint with ten balls, similarly to the above-described embodiment. As shown in the graph, when the number of balls is as many as ten, the bending torque at the time of jamming is reduced. When there are ten balls, as compared to the case with six balls, with the clearance being set the same, the bending torque at the time of jamming is about one third, and the jamming occurs at a different angle. With the six-ball joint, the maximum torque peak appeared in three phases, while, with the ten-ball joint, the maximum torque peak appeared in five phases.

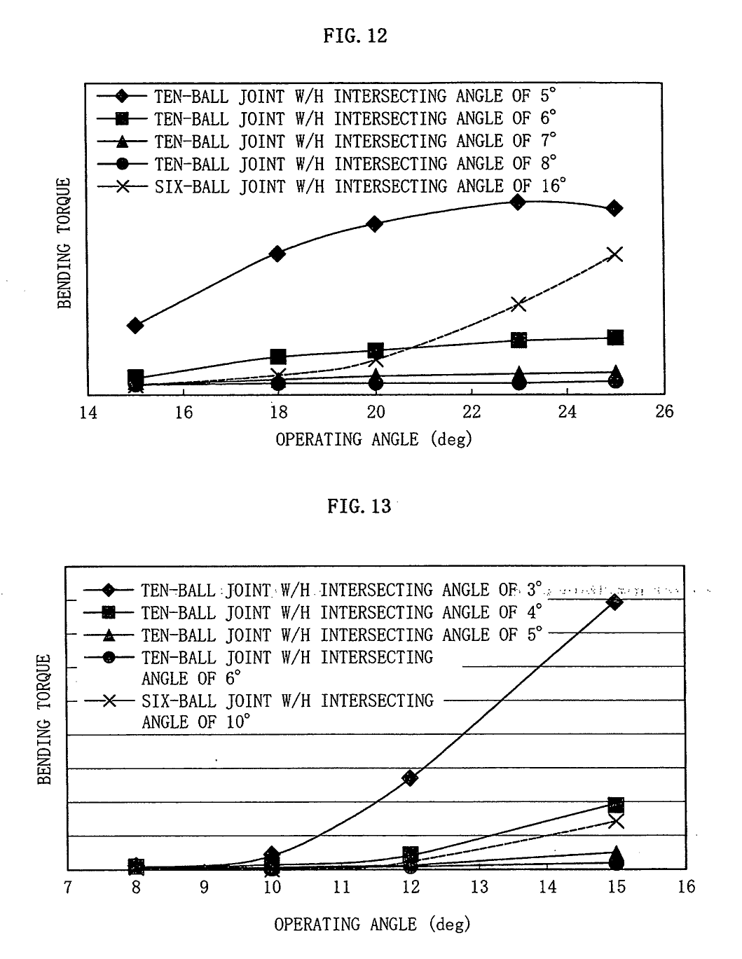

The relationship between the intersecting angle and the operating angle is now explained. FIG. 12 and FIG. 13 show the analysis results of the relationship between the operating angle and bending torque, with ten balls and with the intersecting angle being varied; FIG. 12 shows the case with driveshaft joints and FIG. 13 shows the case with propeller shaft joints. Hereinafter the parenthesized numerals indicate the values with respect to the propeller shaft joints. In these graphs there are also shown the curves indicating the case with six balls and the intersecting angle of 16° (10°). The unit of intersecting angle in the graphs is degree.

It can be seen from the graphs that, when the intersecting angle is 10° (5°) or more, the bending torque is maintained low even when the operating angle is 25° (15°). On the other hand, with the six-ball joints, even though the bending angle is as large as 16° (10°), the bending torque increases rapidly with the increase of the operating angle from around 18° (12°). Accordingly, it is understood that, ten-ball joints with the intersecting angle of 10° (5°) or more have better bending characteristics than six-ball joints. More preferably, the intersecting angle should be 11° (6°) or more.

The operating angle of cross groove constant velocity universal joints required for driveshafts (propeller shafts) is usually about 20° (10°); it suffices if the bending angle remains low within the operating angle range of 25° (15°). The bending characteristics are better if the intersecting angle is large, but as mentioned before, if the intersecting angle is too large, the sliding stroke cannot be made large. The practical range, therefore, of the intersecting angle of ten-ball cross groove constant velocity universal joints for driveshafts (propeller shafts) would be 15° (9°) at most. Accordingly, the intersecting angle β should preferably be 10° (5°) or more and not more than 15° (9°).

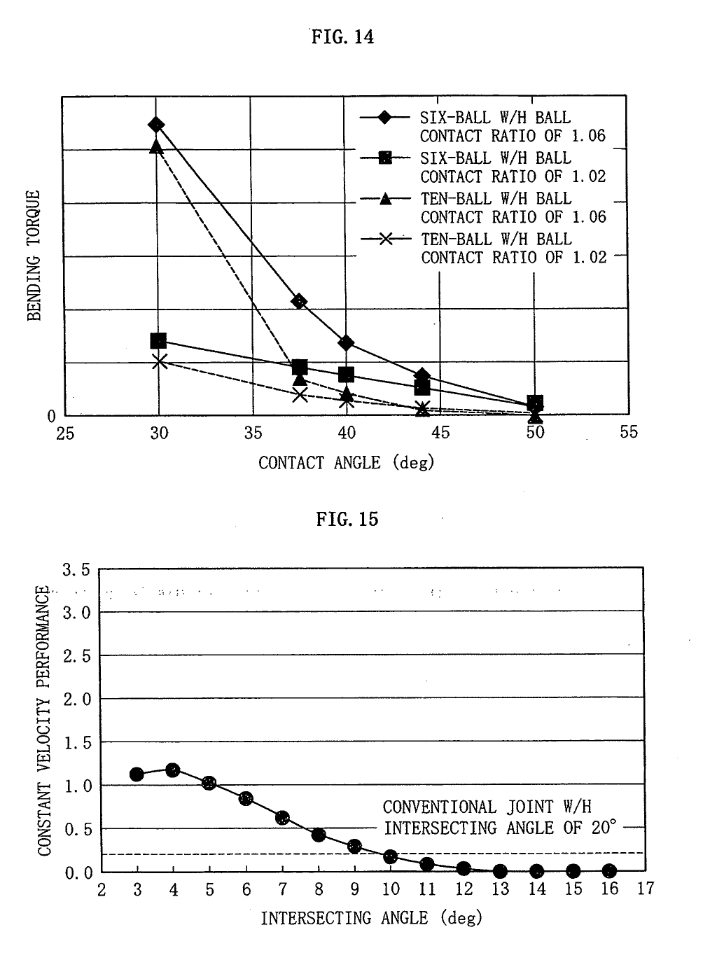

FIG. 14 shows the relationship between the contact angle α and bending torque of joints with ten torque transmission balls and the ball contact ratios of 1.06 and 1.02 and of joints with six balls and the ball contact ratios of 1.6 and 1.02 (four types). The relationship between the contact angle and bending torque will be described with reference to this graph. When there are ten balls, the effect of the ball contact ratio, i.e., the effect of the track shape, is similar to that of six-ball joints. In the case with ten-ball joints, there is substantially no effect of contact ratio when the contact angle is 40°. When there are ten balls and the ball contact ratio is 1.02, then the bending torque is low even when the contact angle is 30°. Therefore, the applicable range of the contact angle is 30 to 50°. If the ball contact ratio is more than 1.02, for example, 1.06 or more, then the contact angle should preferably be 40° or more, at which the ball contact ratio does not affect the bending torque.

FIG. 15 shows changes in the constant velocity performance plotted against intersecting angle at various operating angles of ten-ball cross groove constant velocity universal joints, the horizontal axis representing the intersecting angle and the vertical axis representing the constant velocity performance. The constant velocity performance will be described with reference to this graph. The constant velocity performance is represented by {(input rpm)−(output rpm)}/(input rpm). Generally, the constant velocity performance is better if the operating angle is small and the intersecting angle is large. A conventional six-ball joint with an intersecting angle of 16° (10°) and an operating angle of 20° (10°) which is a requirement to be used for driveshafts (propeller shafts) has a constant velocity performance parameter of about 0.12 (0.07). On the other hand, with ten torque transmitting balls, if the intersecting angle is the same 16° (10°) as the conventional joint, then the parameter is 0.012 (about 0.006) at the operating angle of 20° (10°), which is better than that of the conventional joint. When the operating angle is 20° (10°), with the ten-ball joint, if the intersecting angle is 10° (5°), the constant velocity performance parameter is about 0.16 (0.18), which is about the same as the above conventional joint, and if the intersecting angle is 11° (6°), the constant velocity performance parameter is about 0.08, which is better than the above conventional joint.

As demonstrated above, when the operating angle is 20° (10°) which is a requirement to be used for driveshafts (propeller shafts) and if the intersecting angle is the same, ten-ball joints have better constant velocity performance than six-ball conventional joints. The ten-ball joints have about the same constant velocity performance as the conventional joint even if the intersecting angle is reduced to 10° (6°), and therefore ten-ball joints can have a smaller intersecting angle to increase the operating stroke, without presenting any problem in terms of constant velocity performance.

The balls of ten-ball joints are smaller, and therefore, if the same load is applied to each ball, the surface pressure at the interface between the balls and ball tracks 14a, 14b, 24a, and 24b is higher than that of the joint with six torque transmitting balls. However, since the load applied to each ball is smaller as the number of balls is increased, a ten-ball design without the problem of increased surface pressure is possible.

Ten-ball cross groove constant velocity universal joints are also excellent in productivity. That is, even if the number of balls is eight, the cross groove constant velocity universal joint has better bending torque characteristics than conventional six-ball joints. On the other hand, if the number of balls is eight, the pairs of radially opposite ball tracks in the inner or outer ring are inclined oppositely relative to the axis, and these pairs of ball tracks cannot be machined at the same time, which leads to poor machining efficiency, low productivity, and high costs. In contrast, with ten balls, the pairs of radially opposite ball tracks in the inner or outer ring are inclined in the same direction relative to the axis. Therefore, these pairs of ball tracks can be machined at the same time, and thus ball tracks are machined with good efficiency, leading to good productivity and lower costs.

What is claimed is:

1. A cross groove constant velocity universal joint comprising:
an inner ring having ball tracks in an outer circumferential surface thereof;
a disc-shaped outer ring having ball tracks in an inner circumferential surface;
balls set between the pairs of the inner ring ball tracks and the outer ring ball tracks; and
a cage that retains all the balls within the same plane, and wherein
bolt holes are arranged between adjacent ball tracks of the outer ring, and recesses are formed such as to reduce the outside diameter of the outer ring except for both axial ends, at least between adjacent bolt holes.

2. A cross groove constant velocity universal joint according to claim 1, wherein the outer ring ball tracks and the inner ring ball tracks that are oppositely inclined intersect with an axis at an angle of 4.5° or more and less than 8.5°, and the number of balls is eight.

3. A cross groove constant velocity universal joint according to claim 1, wherein the outer ring ball tracks and the inner ring ball tracks that are oppositely inclined intersect with an axis at an angle of 10° or more and less than 15°, and the number of balls is ten.

4. A cross groove constant velocity universal joint according to claim 1, wherein the outer ring ball tracks and the inner ring ball tracks that are oppositely inclined intersect with an axis at an angle of 5° or more and less than 9°, and the number of balls is ten.
